(19) United States
(12) Patent Application Publication
(10) Pub. No.: US 2025/0176503 A1
(43) Pub. Date: Jun. 5, 2025

(54) NESTING AND DENNING ENCLOSURES

(71) Applicant: Habitat Innovation and Management Pty Ltd, West Bathurst NSW (AU)

(72) Inventors: Michael CALLAN, West Bathurst NSW (AU); Carl TIPPLER, West Bathurst NSW (AU)

(73) Assignee: Habitat Innovation and Management Pty Ltd, West Bathurst NSW (AU)

(21) Appl. No.: 18/969,945

(22) Filed: Dec. 5, 2024

(30) Foreign Application Priority Data
Dec. 5, 2023 (AU) 2023903939

(51) Int. Cl. A01K 31/14; A01K 1/02; A01K 63/00

(52) U.S. Cl. CPC A01K 31/14; A01K 1/02; A01K 63/003

(57) ABSTRACT

The present invention relates to a nesting enclosure for birds mammals or reptiles comprising a body securable to a tree trunk. The body is so shaped that when the enclosure is secured to the tree trunk, a nesting space is defined that is partly bounded by the body and partly bounded by a surface of the tree trunk. The nesting space is adapted to retain therein material shredded from the surface.

### FIELD OF THE INVENTION

This invention provides nesting and denning enclosures or boxes for birds, mammals or reptiles.

### BACKGROUND

A problem of increasing importance is the provision of nesting or denning places for birds, mammals and reptiles. The clearing and harvesting of trees have over time reduced available habitat for native fauna, in particular species that nest, den or roost in tree hollows. Natural formation of tree hollows is a process that takes many years and coupled with the removal of trees has contributed to a critical lack of habitat for many species. In Australia for example it has been estimated that over 15% of vertebrate fauna and many invertebrates depend on tree hollows.

A further problem is that wildfires, which are becoming increasingly common in Australia and elsewhere, can destroy large, forested areas and accordingly much habitat. Large trees having hollows are particularly susceptible to fire.

At least a partial solution to the problem of lost habitat is the provision of nesting or denning boxes or enclosures, being enclosures that provide internal spaces for birds, mammals or reptiles, within which they can nest or den. Many designs have been developed and used.

However, known nesting and denning boxes have a range of problems, including high variability of the microclimates they provide in their internal spaces, cost and short life, and significant maintenance requirements. Many designs are suitable for one or a few species but difficult or impossible to adapt to be attractive to, and suitable for, other species.

Some species present an additional issue, namely a preference for shredding timber into their nest hollows. This may be part of a courtship ritual. An Australian bird species that is an example is the black cockatoo. Providing for such a preference is difficult with nesting boxes or enclosures of known types. Previous attempts to address this issue include the provision of a hardwood sacrificial chewing post to provide a source of timber for birds such as the black cockatoos to chew on and shred timber into the nesting chamber which is found to be an important part of the courtship process for some cockatoo species. Along with chewing post, a ladder structure typically in the form of a galvanised steel mesh or the like is commonly provided to facilitate access to and egress from the nesting chamber of the nesting box for birds and other animals. Such a ladder structure also enables the birds to chew on and shred timber from different parts of the sacrificial chewing post as they land on different levels of the ladder structure. The ladder structure and chewing post combination however has the shortcoming that replacement is required over time as the chewing post gets depleted which incurs expensive labour costs to climb the trees or use a mobile elevated work platform which may either be self-propelled or trailer or truck mounted with a hydraulic lift.

Even for species that do not have the particular behaviour set out in the preceding paragraph, it is believed that the nesting enclosures disclosed may provide a congenial habitat.

Whether a given enclosure is a nesting or denning enclosure essentially depends on the species using it. Accordingly, the terms “nesting enclosure” and “nesting space” will be used in this specification for brevity and ease of reading, but they are to be interpreted as being respectively an enclosure or space for nesting or denning purposes.

### DISCLOSURE OF THE INVENTION

It is an object of the present invention to provide a nesting and denning enclosure which may address the abovementioned issues or which may overcome or at least ameliorate the abovementioned shortcoming or which may provide a useful choice.

In a first aspect, the invention provides a nesting enclosure for birds and animals comprising a body securable to a tree trunk and so shaped that when the enclosure is secured to the tree trunk a nesting space is defined that is partly bounded by the body and partly bounded by a surface of the tree trunk and adapted to retain therein material shredded from the surface of the tree trunk.

In a preferred embodiment, the body comprises a top portion, a base module and an intermediate portion therebetween, the top portion being secured to an upper end of the intermediate portion and the base module being secured to a lower end of the intermediate portion, and the nesting space lying between the base module and the top portion.

The intermediate portion may comprise a body module having an upper locking formation that interlocks with a mating locking formation of the top portion and a lower locking formation that interlocks with a mating locking formation of the base module.

The body module may be one of a plurality of body modules connected end to end and together comprising the body, with members of each adjoining pair of the plurality of body modules being connected by interlocking of the lower interlocking formation of an upper one of the pair with the upper interlocking formation of the lower one of the pair. The body modules are preferably identical to each other.

By this means, the nesting enclosure may be made to provide a selectable range of nesting space volumes, simply by varying the number of body modules to assemble the nesting enclosure.

Preferably, the body module has an external wall, an inner wall and an insulating space therebetween, the inner wall having a surface that faces into the nesting space. The intention is to limit or mitigate extremes of heat or cold within the nesting space.

The body module may comprise flange formations having openings for fasteners to be driven into the tree trunk whereby to secure the body module to the tree trunk. When the body module is secured to the tree trunk the flange formations may lie at least approximately conformably against a surface of the tree trunk.

The body module may be formed from a thermoplastic material by rotational moulding. This is very suitable where separated inner and outer walls are provided.

The top portion is preferably so shaped that when the nesting enclosure is secured to the tree trunk an access opening is defined at least partly by the top portion that is suitable for a bird or animal to enter and leave the nesting space. The access opening may be on one of: a side of the body or a top surface of the nesting enclosure. By the use of different top portions, nesting enclosures may be assembled that are suited to different sizes and species of birds or animals.

A surface of the body module that partially defines the nesting space may be at least approximately cylindrical between locations where the body module in use is in contact with the tree trunk. This feature may be advantageous for temperature control in the nesting space.

In another aspect, the invention provides a nesting enclosure for birds, mammals or reptiles, the nesting enclosure being securable to a tree trunk and so shaped that when the enclosure is secured to the tree trunk, a nesting space is defined that is partly bounded by the enclosure and partly bounded by a surface of the tree trunk and adapted to retain therein material shredded from the surface; wherein the enclosure comprises an assembly of a top module and a base module.

Preferably, the enclosure also comprises a body including the assembly of the top module, the base module and a body section therebetween, the top module being secured to an upper end of the body section; the base module being secured to a lower end of the body section; and the nesting space lying between the base module and the top module.

In a further aspect, the invention provides an artificial habitat for birds and animals comprising a nesting enclosure in any of the embodiments described above or elsewhere herein, with the nesting enclosure being secured to a tree trunk.

In this aspect, preferably a portion of the tree trunk surface that faces into the nesting space and a portion of the tree trunk through which fasteners are driven to secure the nesting enclosure to the tree trunk are prepared by removal of bark whereby to expose the cambium layer of the tree trunk.

The artificial habitat may further include a recess in the portion of the tree trunk facing into the nesting space and from which bark has been removed, the recess extending toward a central region of the tree trunk.

Further, an internal ladder may be cut into the tree trunk surface that faces into the nesting space by cutting a series of horizontal cuts into the tree using a chainsaw or similar mechanical means.

In still another aspect, the invention provides a method for provision of an artificial habitat for birds and animals including the step of securing to a tree trunk a nesting enclosure in any of the embodiments described above or elsewhere herein.

Preferably, the method includes the step of preparing the tree trunk by removal of bark from a defined portion of the tree trunk surface to expose the cambium layer of the tree trunk and thereafter securing the nesting enclosure against the defined portion by fasteners into the defined portion of the tree trunk.

The method may include the step of providing a recess in the portion of the tree trunk facing into the nesting space and from which bark has been removed, the recess extending toward a central region of the tree trunk.

Other embodiments and aspects of the invention will be described in the detailed description below and in the attached claims.

In this specification, the word “comprise” and derivatives thereof including “comprising and “comprised of”, when used in relation to integers, elements or steps, is to be taken as indicating the presence of those integers, elements or steps, but is not to be taken, unless the contrary is explicitly stated, as precluding the presence of other integers, elements or steps.

Nothing in this specification is to be taken as an admission that any thing or action is part of the common general knowledge of persons skilled in relevant arts in Australia or elsewhere.

### BRIEF DESCRIPTION OF THE VIEWS OF THE DRAWINGS

FIG. 1 is a perspective view of a nesting enclosure according to the invention secured on a tree to form an artificial habitat for birds or mammals or reptiles;

FIG. 2 is a perspective exploded view of the nesting enclosure shown in FIG. 1;

FIG. 3 is a cross-sectional view of the habitat shown in FIG. 1, the section being taken on a horizontal plane;

FIG. 4 is a perspective view of a body module of the nesting enclosure shown in FIG. 1;

FIG. 5 is a perspective view of a base module of the nesting enclosure shown in FIG. 1;

FIG. 6 is a perspective view of a top module of the nesting enclosure shown in FIG. 1;

FIG. 7 is a perspective view of a further nesting enclosure according to the invention;

FIG. 8 is a perspective view of a top module of the nesting enclosure shown in FIG. 7;

FIG. 9 is a perspective view of the body module shown in FIG. 4, now inverted;

FIG. 10 is an elevation of the body module shown in FIG. 9 seen from its lower end;

FIG. 11 is a front elevation of the body module shown in FIG. 9 with its lower end uppermost;

FIG. 12 is cross-sectional view of the body module as shown in FIG. 11, the section being taken on a vertical plane “B-B” as shown in FIG. 11;

FIG. 13 is a view of the base module shown in FIG. 5, as seen from above;

FIG. 14 is a front elevation of the base module shown in FIG. 13;

FIG. 15 is a cross-sectional view of the base module shown in FIG. 14, the section being taken on a vertical plane “C-C” as shown in FIG. 14;

FIG. 16 is a front elevation of the top module shown in FIG. 8;

FIG. 17 is a cross-sectional view of the top module shown in FIG. 16, the section being taken on a vertical plane “D-D” as shown in FIG. 16;

FIG. 18 is a front elevation of the top module shown in FIG. 6;

FIG. 19 is a cross-sectional view of the top module shown in FIG. 18, the section being taken on plane “E-E” shown in FIG. 18;

FIG. 20 is a perspective view of a tree trunk prepared for fitment of the enclosure as shown in FIG. 1;

FIG. 21 is a perspective view of a yet further nesting enclosure according to the invention secured on a tree trunk to form an artificial habitat for birds, mammals or reptiles;

FIG. 22 is a cross-sectional view on a vertical plane through the nesting enclosure shown in FIG. 21.

### DETAILED DESCRIPTION OF PREFERRED EMBODIMENTS

The invention provides nesting enclosures for birds, mammals or reptiles, each comprising an assembly that can be secured to a tree trunk (or other surface) above ground level, that then provides an internal nesting or denning space suitable for them and is accessible to them through a suitably shaped and sized opening in the assembly.

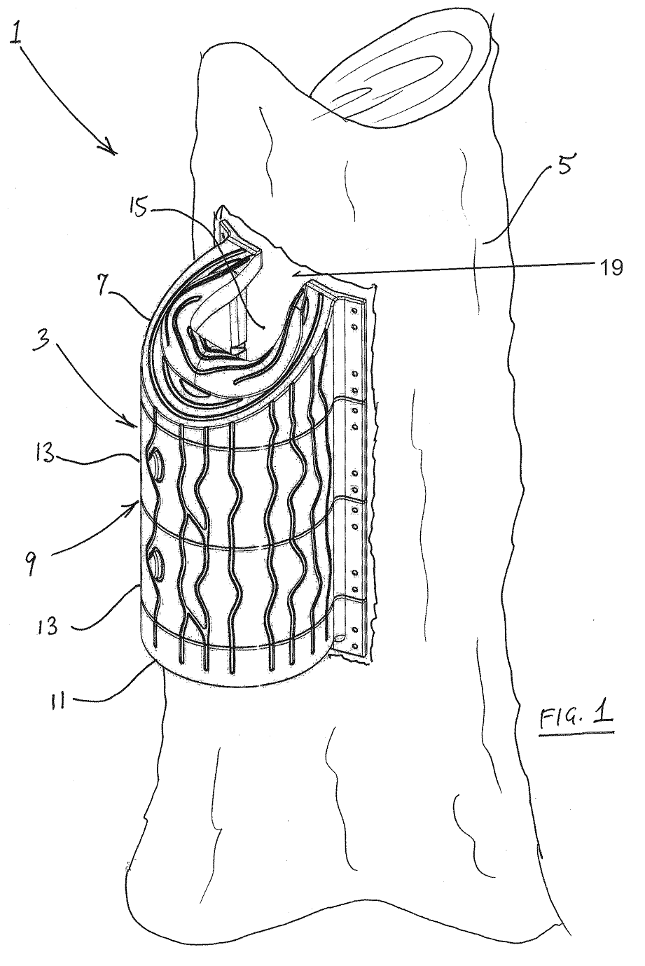

FIG. 1 is a perspective view of an artificial habitat 1 for birds, mammals or reptiles according to the invention, comprising a nesting or denning enclosure 3 secured to a tree trunk 5 at a location above ground level. Suitable methods for preparation of tree trunk 5 before securing thereto of nesting enclosure 3 will be described below.

In reading the following description, terms connoting orientation, such as “upper”, “lower”, “top”, “bottom”, “above”, below” and the like, are used for simplicity of description and in a way compatible with a nesting enclosure secured to a substantially vertical tree trunk, as shown in FIG. 1. This is expected to be the most likely way in which nesting or denning enclosures according to the invention are used. Applications in which the nesting or denning enclosure is differently oriented or applied are not intended to be excluded.

However, the description herein is, for simplicity, based on nesting enclosures being, or adapted to be, secured to a tree trunk. This is not intended to limit the scope of the invention. Nesting or denning enclosures as described may also be secured to or on other structures or surfaces. As one example, there is the potential for securing such an enclosure to a log, timber slab or the like for avicultural purposes. The terms “nesting enclosure” and “nesting space” will be used in this specification for brevity and ease of reading, but are to be interpreted as being respectively an enclosure or space for nesting or denning purposes.

Nesting enclosure 3 comprises three elements, namely a top module 7, a body 9 and a base module 11, the top module 7 being secured to an upper end of the body 9 and the base module 11 being secured to a lower end of the body 9. Body 9 comprises two identical body modules 13, secured to each other. Top module 7 comprises an access opening 15 adapted for a bird, mammal or reptile to enter and leave nesting enclosure 3.

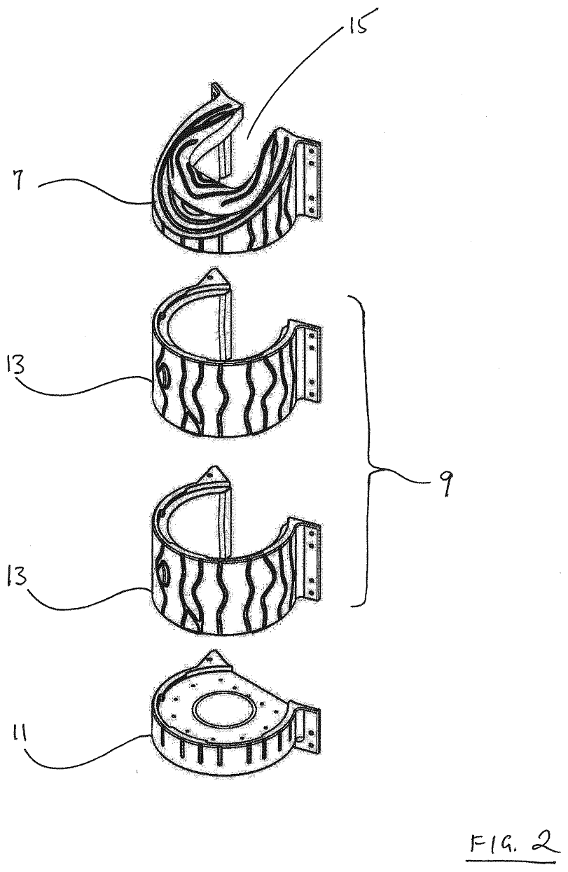

FIG. 2 is an exploded view of nesting enclosure 3, now in isolation from tree trunk 5. (This Figure shows the distinction between body 9 and the two body modules 13 arranged end-to-end that comprise body 9.)

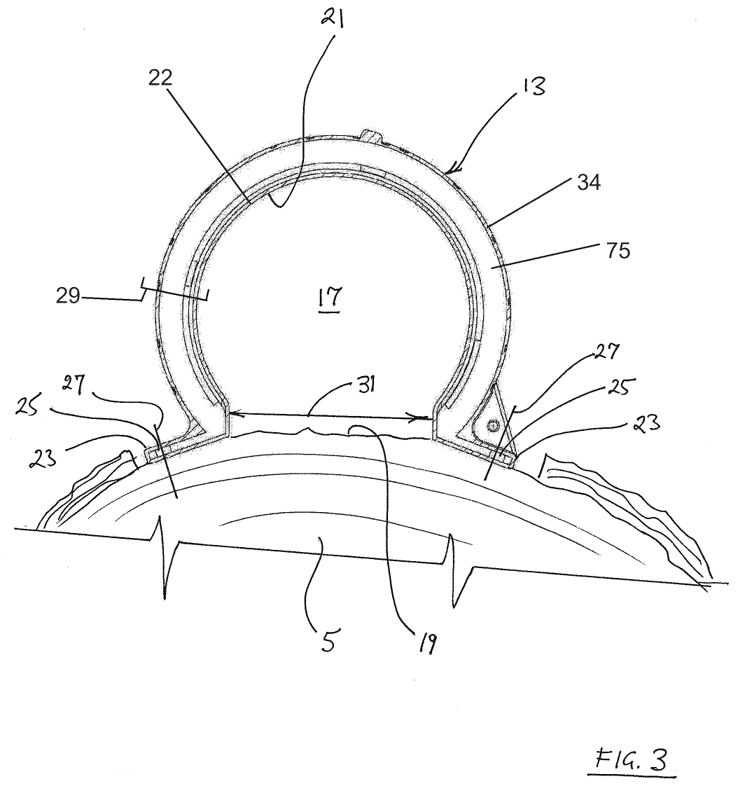

FIG. 3 is a horizontal cross-sectional view of body 9 of nesting enclosure 3 and a portion of trunk 5, the section being taken on a plane (plane “A-A” shown in FIG. 12) at a height between the upper and lower ends of one of body modules 13. Only elements that actually lie on the section plane A-A are shown in FIG. 3. As shown by FIG. 3, an internal nesting space 17 is defined and provided by, in combination, the nesting enclosure 3 and tree trunk 5, more specifically the portion of tree trunk surface 19 to which it is secured. That is, internal nesting space 17 is bounded partly by the nesting enclosure 3, more particularly inner surfaces 21 of body modules 13, and partly by the tree trunk surface 19 to which nesting enclosure 3 is secured. This means that a bird or animal occupying internal nesting space 17 can shred timber into the nesting space 17 from the trunk surface 19 that faces into nesting space 17. This is a known behaviour of certain species such as black cockatoos. This feature increases the chance that such species will select the nesting enclosure to occupy. The configuration of the nesting enclosure 3 is such that material so shredded is retained within the nesting space 17.

The arrangement shown in FIG. 3 is generally typical of positions along the whole height of body 9. As will be apparent from FIGS. 2 and 3, internal nesting space 17 is also bounded by, and lies between, top module 7 and base module 11, with access opening 15 enabling a bird or animal to enter or leave nesting space 17.

Either body module 13 (or both) in use can be secured to tree trunk 5 by placing its two flanges 23 against prepared surface 19 of the tree trunk 5 and placing suitable fasteners (eg screws or nails) through holes 25 (as represented only by their centrelines 27 in FIG. 3) and extending into trunk 5.

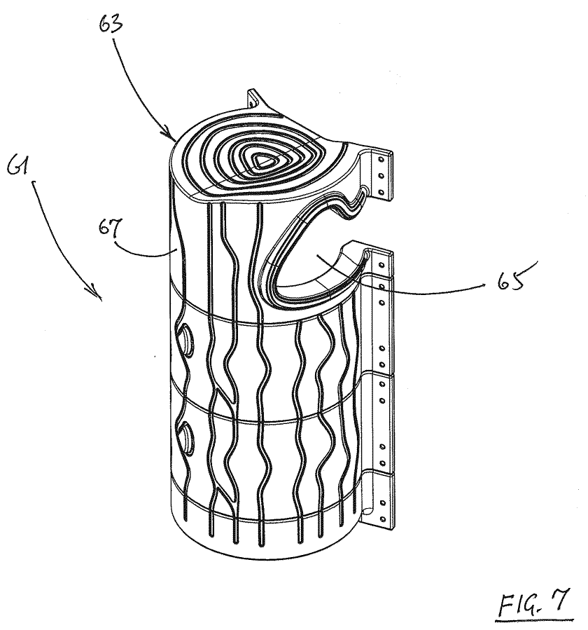

FIG. 4 shows a body module 13. (See also FIGS. 9-12.) Extending from one flange 23 to the other flange 23 is a wall structure 29 of body module 13 that in use (as shown in FIG. 1) extends vertically and that is generally cylindrical except at a circumferential sector corresponding to a gap 31 between the flanges 23, so that nesting space 17 is left between wall structure 29 and tree trunk surface 19. Wall structure 29 has inwardly facing surface 21 and an outwardly facing surface 33.

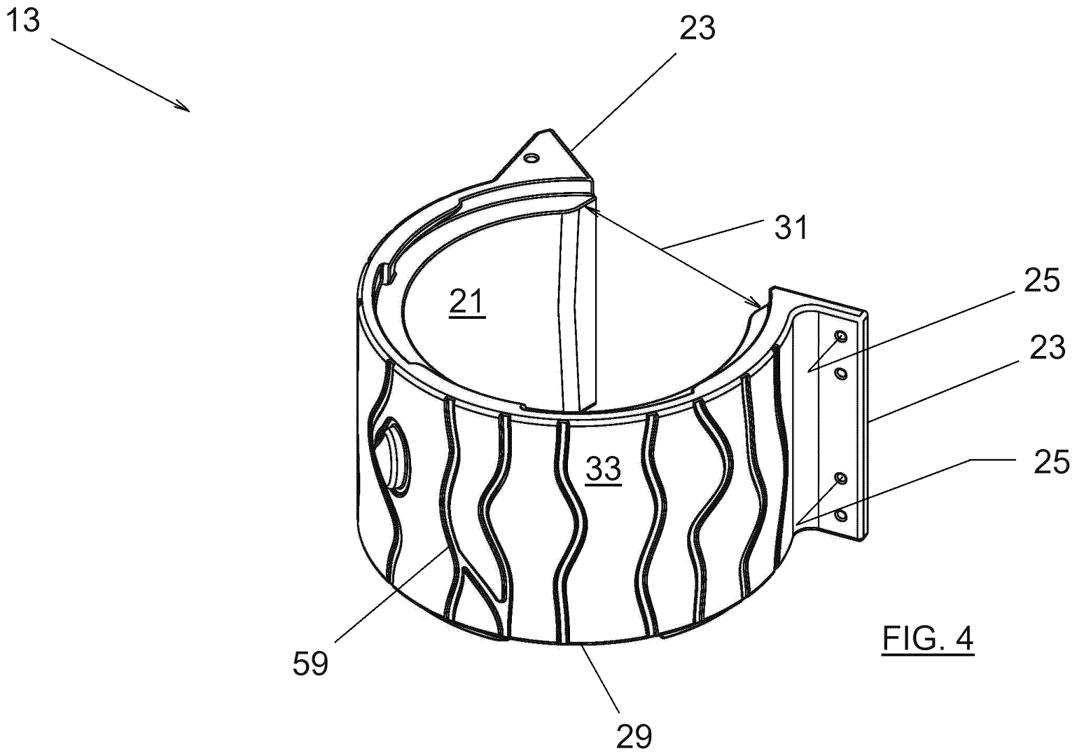

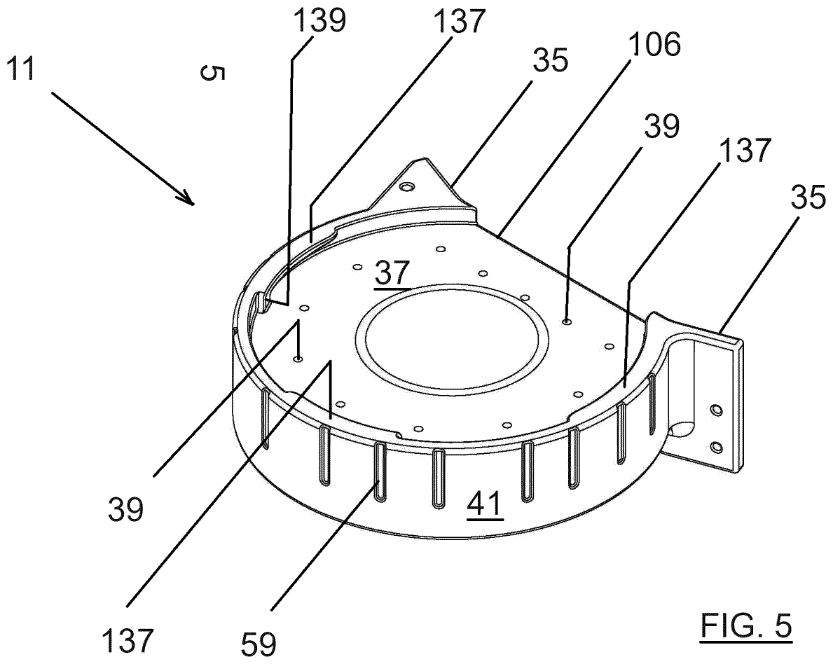

FIG. 5 shows base module 11. Base module 11 also has flanges 35 that enable it to be secured to tree trunk surface 19 in the same way as body modules 13. Base module 11 has a surface 37 that faces upwardly into (and so partly bounds) nesting space 17 when base module 11 is secured to a body module 13 of body 9. Drainage holes 39 are formed in base module 11, extending downwardly from surface 37, so that in use liquids can drain out of nesting space 17. Outer surface 41 of base module 11 is cylindrical except between flanges 35, and when base module 11 is secured to the lower body module 13, forms a continuation of outer surface 33 of body module 13.

FIG. 6 and FIGS. 18 and 19 show top module 7. Top module 7 has flanges 43 that can be secured against tree trunk surface 19 in the same way as flanges 23 of body modules 13 and flanges 35 of base module 11. Top module 7 has an upwardly extending wall structure 45 with an outer surface 47 and inner surface 49. Wall structure 45, when top module 7 is secured to upper body module 13 for use, forms an upward extension of wall structure 29 of body modules 13, its inner and outer surfaces 49 and 47 forming continuations of surfaces 21 and 33 of body modules 13. Between flanges 43 is a gap 51 of approximately the same width as gap 31. An upper wall structure 53 of top module 7 has an outer surface 55 and a lower surface 50 (see FIG. 19). Inner surface 49 and lower surface 50 further partly define nesting space 17. Opening 15 in wall structure 53 is contiguous with gap 51 of body module 13 and may be shaped and proportioned suitably to provide access to nesting space 17 by a defined species.

For maximum acceptability to intended occupant species, top module 7, body module(s) 13 and base module 11 may be formed with natural-looking features such as grooves 59 in their respective outer surfaces 47, 53, 33 and 41 to better resemble wood surfaces. Also, suitable pigmentation of the materials used is preferably chosen to be natural-looking.

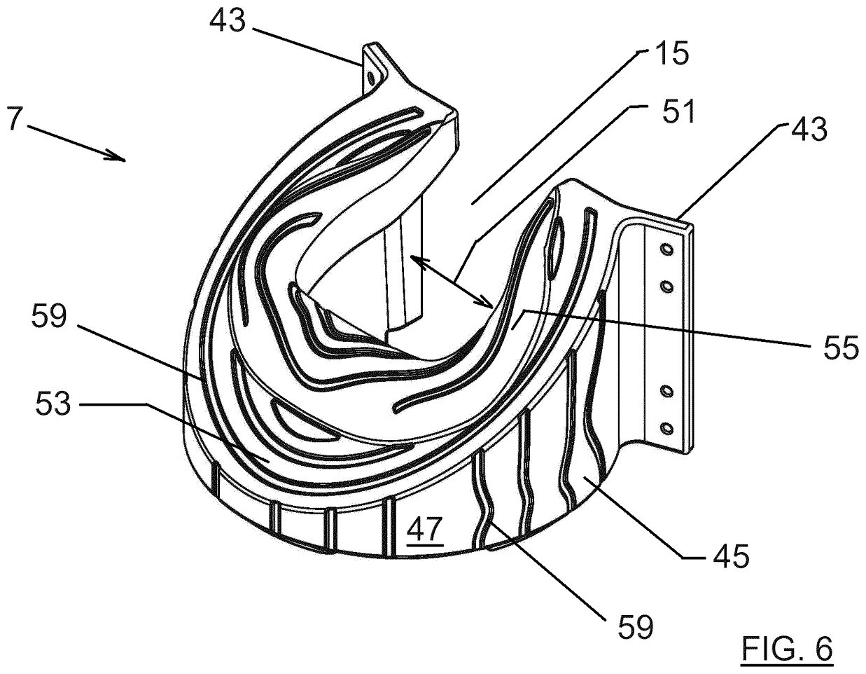

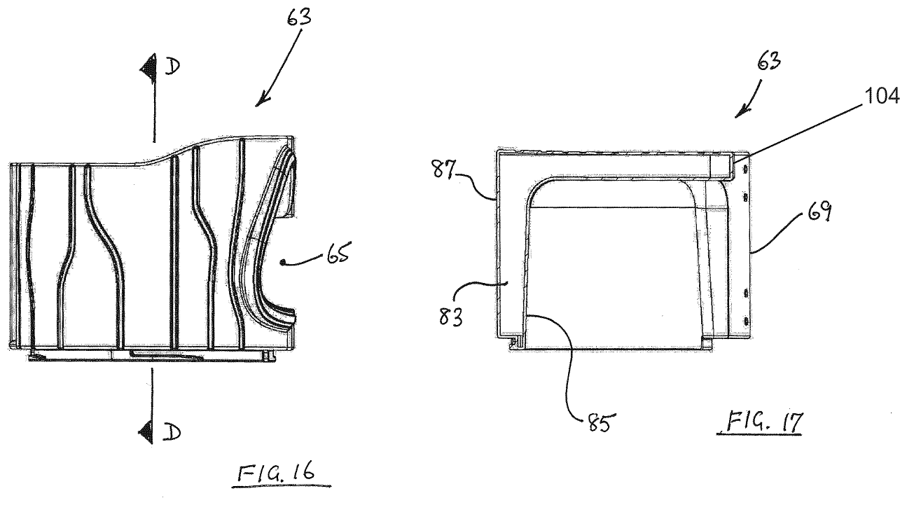

Essentially, nesting enclosure 3 comprises three types of module namely top module 7, two body modules 13, and base module 11. This and the way the modules are secured to each other, described below, enables a range of nesting enclosures to be assembled that are within the scope of the invention but that differ from each other in various ways. As an example, FIG. 7 shows a nesting enclosure 61 that is identical to nesting enclosure 3 except for having a top module 63 different from top module 7, in which an access opening 65 is located in a side wall 67. Nesting enclosure 61 may be preferred by some species and access opening 65 shaped and sized for them. FIG. 8 shows top module 63, which is adapted to be secured to an upper end of a body module 13 in the same way as top module 7. Further, top module 63 has flanges 69 with fastener holes 71 so that it can be secured to tree trunk surface 19 in the same way as top module 7 or body modules 13 or base module 11. Although not essential, access opening 65 extends in use to the tree surface (such as 19, not shown). FIGS. 16 and 17 also show top module 63.

Still other nesting enclosure configurations may be assembled by varying the number of body modules 13 used to form body 9. This is achieved by providing a connection scheme, whereby the modules are assembled and then held together, as follows. Each body module 13 is configured at its upper end to interlock with the lower end of each top module (for example 7 or 63) and configured at its lower end to interlock with the base module 11. Further, the lower end of body module 13 is configured to interlock with the upper end of an identical body module 13. It follows that the body 9 can comprise one body module 13, or two (as in nesting enclosure 3) or more. It is even possible to assemble a nesting enclosure comprising only a top module (7 or 63) secured directly to a base module 11, with no body modules 13 (hence no body 9) at all. In such an embodiment, the top module 7 or 63 is secured directly to an upper end of the base module 11 to form the nesting enclosure. By way of example, the top module 7 or 63 and base module 11 may be connected by interlocking of the interlocking formations provided on the top module 7 or 63 and base module 11 respectively.

Interlocking of modules 7 (or 63), 11, and 13 in this scheme is by a bayonet-type arrangement that will be explained by reference to FIGS. 9 and 5. As shown in FIG. 9 (which shows body module 13 inverted), a male locking formation 129 on one end (in use, the lower end) of body module 13 has three outwardly protruding flanges 131 each with a stop 133, the flanges spaced apart from a surface 135. Referring now to FIG. 5, base module 11 has three flanges 137 that extend inwardly from a wall formation 134, each with a stop 139, the flanges 137 being spaced apart from surface 37. To secure base module 11 to a body module 13, male locking formation 129 is first moved towards base module 11 so that surfaces 135 and 37 approach each other axially. Then, body module 13 is rotated relative to base module 11 until flanges 131 are received between flanges 137 and surface 37, stops 133 abut stops 139, and male locking formation 129 is received within formation 34.

Comparing FIG. 5 with FIG. 4 which shows the other end (in use the upper end) of body module 13 it can be seen that they are identically configured (and with the same proportions and dimensions of corresponding parts). Top module 7 is formed at its lower end with a male locking formation (not visible in FIG. 3) the same as locking formation 129 of body module 13.

Alternatives to the bayonet fitting arrangement as described above can be provided if desired in accordance with known methods of the mechanical art. For example only, single- or multi-start male and female thread formations (not shown) could be used.

It is not necessary to provide for interconnection of top, body and base modules in these ways, but it does simplify provision of multiple nesting enclosure configurations. Also, nesting enclosures such as 3 or 61 can be readily modified if required.

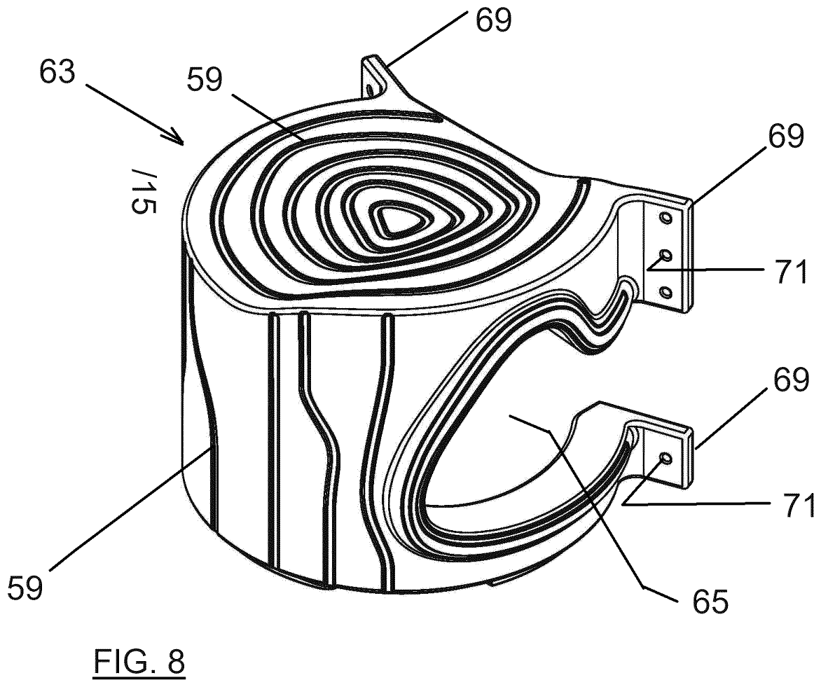

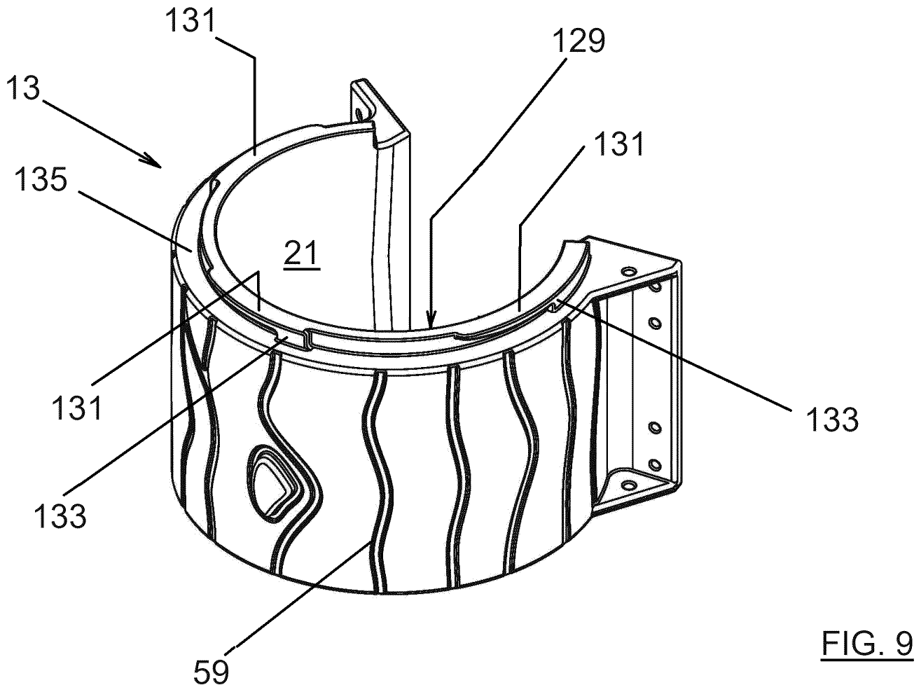

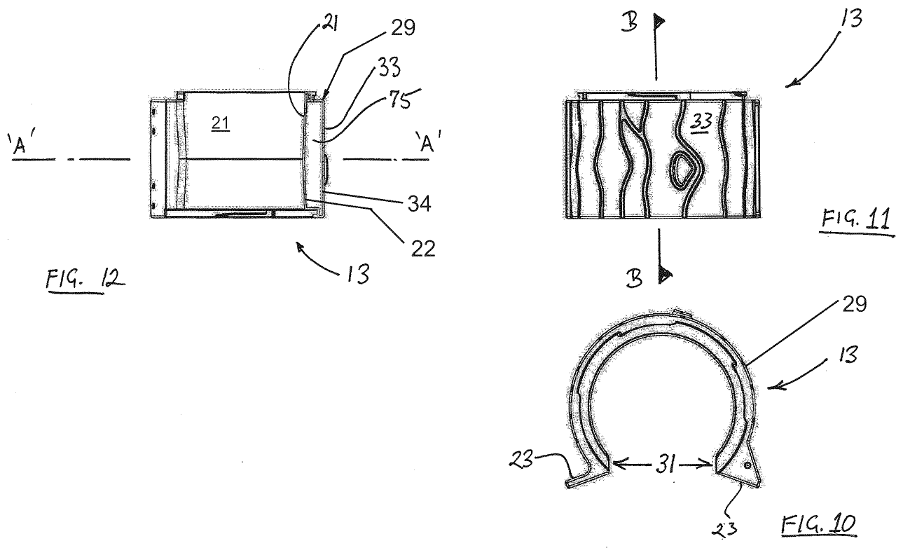

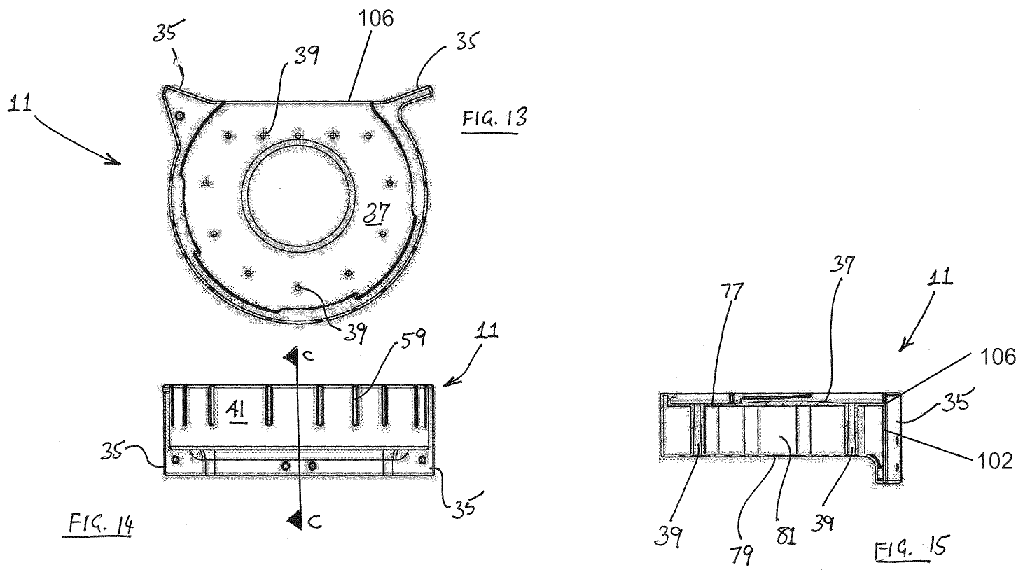

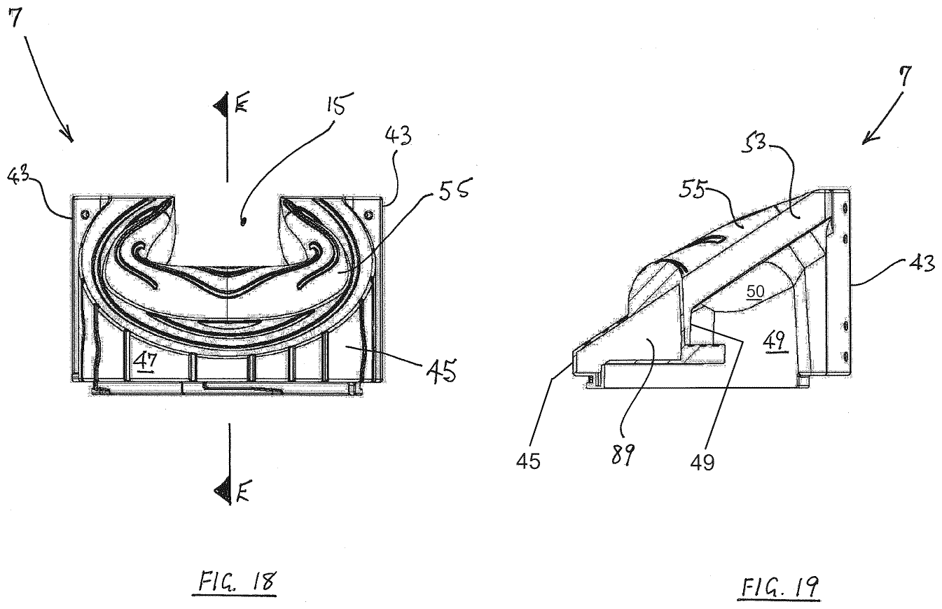

It is desirable that variability in temperatures in the internal nesting spaces (such as nesting space 17 of enclosure 3) be limited. To this end, some or all modules such as top modules 7 and 63, base module 11 and body modules 13 may be formed with inner and outer walls that are spaced apart with an insulating space between them. FIGS. 10-12 show body module 13, with FIG. 12 being a sectional view showing wall structure 29 comprising an inner wall 22 and an outer wall 34, with an empty insulating space 75 between them. FIGS. 13-15 show base module 11, with FIG. 15 being a section showing upper and lower walls 77 and 79 respectively and an empty space 81 between them. FIGS. 16 and 17 show top module 63, with FIG. 17 being a sectional view showing an insulating space 83 between inner and outer walls 85 and 87 respectively. FIGS. 18 and 19 show top module 7, which also has an empty space 89 within wall structure 45.

Such twin-walled structures can be achieved by forming the described modules using the technique of rotational moulding in suitable plastics materials. In this technique, a charge of a thermoplastic material is placed in a mould (not shown) with a closed cavity shaped to have a boundary that is a female version of the element being produced, with the mould being heated and rotated so that molten thermoplastic forms the element as a skin within the cavity. The mould is then cooled so that the thermoplastic material solidifies in the desired form of the element. An alternative possibility is blow moulding.

An alternative approach is to produce elements by injection moulding, thermoforming or otherwise manufacturing of the internal and internal walls separately and thereafter joining them, for example by a suitable adhesive or by heat welding.

A suitable plastic material for modules 7, 13, 11 and 63 is LLDPE, at least when formed by rotational moulding. Double-walled construction as shown may not be essential in all applications but is generally desirable in the interests of limiting temperature variability.

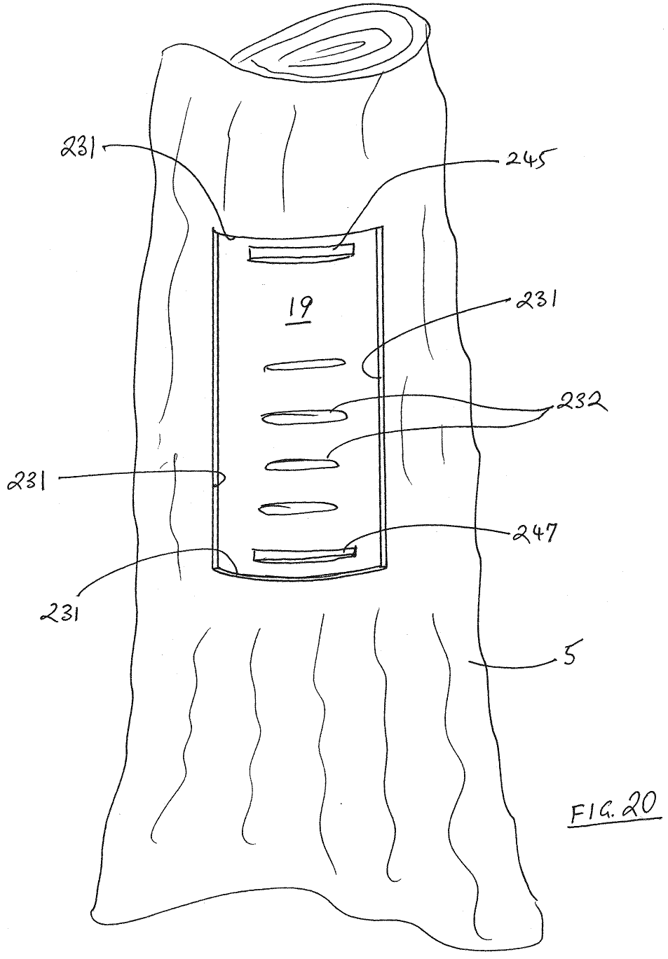

Suitable preparation of a tree trunk for use of nesting enclosures according to the invention will now be described, using trunk 5 and nesting enclosure 3 as being representative. Referring to FIG. 20, a suitable and preferable method for many tree species comprises the step of firstly removing the bark layer over an area 19 of trunk 5 having vertical and peripheral dimensions sufficient for assembled nesting enclosure 3 to lie at least approximately conformably against the exposed surface 19 with small (preferably less than about 5 centimetres) clearance from remaining bark. This can be done by for example cutting around the intended periphery 231 of area 19 with a small chainsaw and then knocking, peeling or prying off the bark and cambium layer inside the periphery to expose sapwood. Grooves 232 (preferably horizontal) may optionally be cut into the surface 19 to provide a “ladder” inside nesting space 17. Flanges 23, 43 and 35 in use lie against or adjacent to surface 19, preferably at least approximately conformably. Flanges 23, 35, 43 or 69 are configured as shown in the Figures to be able to lie against a cylindrical surface of a chosen radius, but because tree trunks taper, are irregular and are of various sizes, will not necessarily always do so precisely in practice. Some gaps between surface 19 and the flanges (23, 35, 43, 69) may be acceptable, and even enhance ventilation, although such gaps preferably will be sufficiently small firstly to ensure all or most material shredded from surface 19 is retained within nesting space 17, and secondly to avoid access by unwanted species. Retention of shredded material is a reason for the fact that surface 102 of base module 11 FIG. 15) and its upper edge 106 (FIG. 5) are not shaped to lie against a cylindrical surface.

Moreover, although each of modules has flanges (23, 43, 35, 69) with holes for fasteners, in practice it may not be necessary to use fasteners through all flanges of a given nesting enclosure according to the invention, because when nesting enclosures 3 or 61 (for example) are assembled, the various modules are locked together.

While FIG. 3 shows surface 19 somewhat flattened where it faces into nesting space 17, this is optional. Some sculpting (flattening) of surface 19 with the chainsaw, as shown by grooves 245 and 247, may be appropriate to allow surfaces 102 and 104 respectively (FIGS. 15 and 17) of base and top modules such as 11 and 63 to lie against the completed surface 19. Once preparation of surface 19 is completed, enclosure 3 (or 61) may then be secured by suitable fasteners to the surface 19. (The use of fasteners may if desired be avoided by passing one or more bands of suitable material around both trunk 5 and assembled enclosure 3 or 61 instead.)

Still further embodiments of the invention are possible. For example, it is possible to make top modules, base modules and body modules (not shown, corresponding respectively to 7, 63, 11 and 13) that can be assembled and secured together as described above, but that have different outer shapes and/or different internal nesting space shapes, so that a more natural-looking shape is produced.

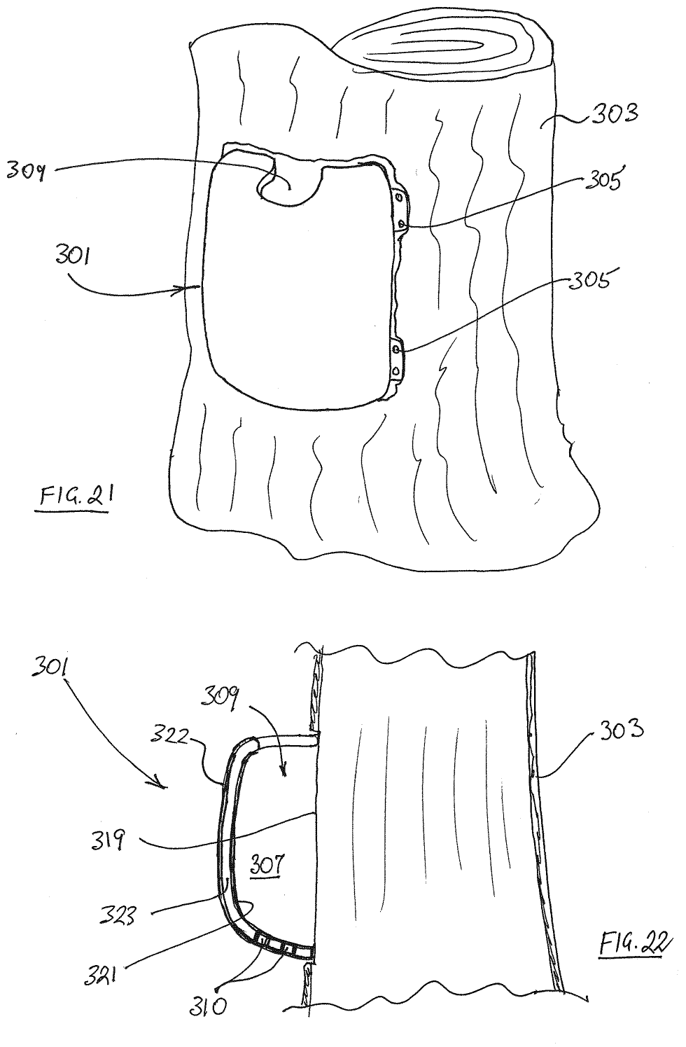

A yet further option is to provide a nesting enclosure that does not use the particular modular approach as described herein to enable a variety of nesting enclosures to be assembled from a small number of modules. FIGS. 21 and 22 show a single-part nesting enclosure 301 secured to a tree trunk 303 by fasteners 305 in the same way as nesting enclosure 3. Nesting enclosure 301 is not an assembly of separate modules like nesting enclosure 3, and may have any desired shape, but does however have the feature of being shaped for approximately conformable mountable to tree trunk 303 so that the internal nesting space 307 it provides is defined partly by the enclosure 301 and partly by a prepared surface 319 of the tree trunk 303. Moreover, nesting enclosure is like the nesting enclosures 3, 61 and others assembled from the modules described configured to retain in its internal nesting space 307 material shredded from the tree trunk surface against which it is secured. Surface 319 may be prepared in essentially the same way as surface 19. An access opening 309 is provided in enclosure 301 and drain holes 310 are formed at the bottom end. Optionally, as shown in FIG. 22, nesting enclosure 301 could be made with spaced-apart inner and outer walls 321 and 322 respectively and an insulating space 323 therebetween, by any of the methods mentioned above in relation to nesting enclosure 3. Nesting enclosure 301 is shown as a one-piece element, but it would be possible (not shown) to provide for a range of alternative access openings by the use of a separate access-opening section comprising the access opening and securable to the remaining part of the enclosure. Similarly, a separable bottom section (not shown) removable for cleaning out of the nesting space could be provided if desired.

1. A nesting enclosure for birds mammals or reptiles comprising a body securable to a tree trunk and so shaped that when the enclosure is secured to the tree trunk a nesting space is defined that is partly bounded by the body and partly bounded by a surface of the tree trunk and adapted to retain therein material shredded from the surface.

2. A nesting enclosure according to claim 1, wherein:
the body comprises an assembly of a top module, a base module and a body section therebetween, the top module being secured to an upper end of the body section;
the base module is secured to a lower end of the body section; and
the nesting space lying between the base module and the top module.

3. A nesting enclosure according to claim 2, wherein:
the body section comprises a body module having an upper locking formation that interlocks with a mating locking formation of the top module and a lower locking formation that interlocks with a mating locking formation of the base module.

4. A nesting enclosure according to claim 3, wherein:
the body module is one of a plurality of body modules connected end to end and together comprising the body; and
members of each adjoining pair of the plurality of body modules are connected by interlocking of the lower interlocking formation of an upper one of the pair with the upper interlocking formation of the lower one of the pair.

5. A nesting enclosure according to claim 4, wherein the body modules are identical to each other.

6. A nesting enclosure according to claim 3, wherein the body module has an external wall, an inner wall and an insulating space therebetween, the inner wall having a surface that faces into the nesting space.

7. A nesting enclosure according to claim 3, wherein the body module comprises flange formations having openings for fasteners to be driven into the tree trunk whereby to secure the body module to the tree trunk.

8. A nesting enclosure according to claim 7, wherein when the body module is secured to the tree trunk the flange formations lie at least approximately conformably against a surface of the tree trunk.

9. A nesting enclosure according to claim 6, wherein the body module is formed from a thermoplastic material by rotational moulding.

10. A nesting enclosure according to claim 2, wherein the top module is so shaped that when the nesting enclosure is secured to the tree trunk an access opening is defined at least partly by the top portion that is suitable for a bird or animal to enter and leave the nesting space.

11. A nesting enclosure according to claim 10 wherein the access opening is on one of: a side of the body; or a top surface of the nesting enclosure.

12. A nesting enclosure according to claim 2, wherein a surface of the body module that partially defines the nesting space is at least approximately cylindrical between locations where the body module in use is in contact with the tree trunk.

13. An artificial habitat for birds mammals or reptiles comprising a nesting enclosure according to claim 1, secured to a tree trunk.

14. An artificial habitat according to claim 13, wherein a portion of the tree trunk surface that faces into the nesting space and a portion of the tree trunk through which fasteners are driven to secure the nesting enclosure to the tree trunk are prepared by removal of bark whereby to expose the cambium layer of the tree trunk.

15. An artificial habitat according to claim 13, further including a recess in the portion of the tree trunk facing into the nesting space and from which bark has been removed, the recess extending toward a central region of the tree trunk.

16. A method for provision of an artificial habitat for birds and animals including the step of securing to a tree trunk a nesting enclosure according to claim 1.

17. The method according to claim 16, including the step of preparing the tree trunk by removal of bark from a defined portion of the tree trunk surface to expose the cambium layer of the tree trunk and thereafter securing the nesting enclosure against the defined portion by fasteners into the defined portion of the tree trunk.

18. The method according to claim 17 including the step of providing a recess in the portion of the tree trunk facing into the nesting space and from which bark has been removed, the recess extending toward a central region of the tree trunk.

19. The method according to claim 17, including the step of providing an internal ladder by cutting a series of horizontal cuts into the tree trunk surface that faces into the nesting space.

20. A nesting enclosure for birds mammals or reptiles comprising a body securable to a tree trunk and so shaped that when the enclosure is secured to the tree trunk a nesting space is defined that is substantially closed save for an access opening in the nesting enclosure the nesting space being partly bounded by the body and partly bounded by a surface of the tree trunk.

21. A nesting enclosure for birds mammals or reptiles, the nesting enclosure being securable to a tree trunk and so shaped that when the enclosure is secured to the tree trunk, a nesting space is defined that is partly bounded by the enclosure and partly bounded by a surface of the tree trunk and adapted to retain therein material shredded from the surface;
wherein the enclosure comprises an assembly of a top module and a base module.

22. The nesting enclosure of claim 21, wherein the enclosure also comprises a body including the assembly of the top module, the base module and a body section therebetween, the top module being secured to an upper end of the body section; the base module being secured to a lower end of the body section; and the nesting space lying between the base module and the top module.
